(19) United States
(12) Patent Application Publication
(10) Pub. No.: US 2025/0214475 A1
(43) Pub. Date: Jul. 3, 2025

(54) POWER SUPPLY SUPPORT DEVICE

(71) Applicant: TOYOTA JIDOSHA KABUSHIKI KAISHA, Toyota-shi (JP)

(72) Inventors: Takahiro AOKI, Saitama-shi (JP); Ibuki SHIMADA, Miyoshi-shi (JP); Hirohito IDE, Nagoya-shi (JP); Seiji SUYAMA, Nagakute-shi (JP); Kiyotaka MORIIZUMI, Nisshin-shi (JP); Kazuyuki INOUE, Nagoya-shi (JP); Tomokazu MAYA, Nagoya-shi (JP); Naoya OKA, Nagoya-shi (JP)

(73) Assignee: TOYOTA JIDOSHA KABUSHIKI KAISHA, Toyota-shi (JP)

(21) Appl. No.: 18/904,729

(22) Filed: Oct. 2, 2024

(30) Foreign Application Priority Data
Dec. 28, 2023 (JP) 2023-223161

(51) Int. Cl. B60L 53/66; B60L 53/57; G01C 21/34; G08G 1/01

(52) U.S. Cl. CPC B60L 53/66; B60L 53/57; G01C 21/3407; G08G 1/0112; G08G 1/0137

(57) ABSTRACT

A power supply support device includes a control unit that acquires traffic jam prediction information predicting a traffic jam of a vehicle generated for each road, and determines, based on the acquired traffic jam prediction information, a distribution vehicle of a power supply vehicle that supplies power to a general vehicle having an external power supply function.

### CROSS-REFERENCE TO RELATED APPLICATION

This application claims priority to Japanese Patent Application No. 2023-223161 filed on Dec. 28, 2023, incorporated herein by reference in its entirety.

### BACKGROUND

### 1. Technical Field

The present disclosure relates to a power supply support device.

### 2. Description of Related Art

Japanese Unexamined Patent Application Publication No. 2020-047014 (JP 2020-047014 A) discloses a dispatch management system that manages dispatch of a plurality of fuel cell electric vehicles (FCVs) to a power-deficient area where a power shortage has occurred.

### SUMMARY

It is known that battery electric vehicles that travel by storing power supplied from the outside of the vehicle have a shorter cruising range than gasoline-powered vehicles. Therefore, it is pointed out that the battery electric vehicles cannot be charged and go out of power when the vehicle is caught in large-scale traffic congestion exceeding the cruising range, or when the vehicle is stuck due to a sudden change in the weather, for example.

It is an object of the present disclosure to provide a power supply support device that suppresses a battery electric vehicle going out of power even if being caught in traffic congestion.

An aspect of the present disclosure provides a power supply support device including a control unit that acquires traffic congestion prediction information on predicted traffic congestion with vehicles generated for each road, and that determines distribution of a power supply vehicle that supplies power to a general vehicle having an external power supply function based on the acquired traffic congestion prediction information.

With the power supply support device according to the aspect of the present disclosure, it is less likely that the battery electric vehicle goes out of power even if being caught in traffic congestion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a block diagram illustrating a configuration of a power supply support device according to an embodiment of the present disclosure;

FIG. 3 is a block-diagram illustrating a configuration of a power supply vehicle and a normal vehicle according to an embodiment of the present disclosure; and

FIG. 4 is a flowchart illustrating an operation of a system according to an embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of the present embodiment, description of the same or corresponding components will be appropriately omitted or simplified.

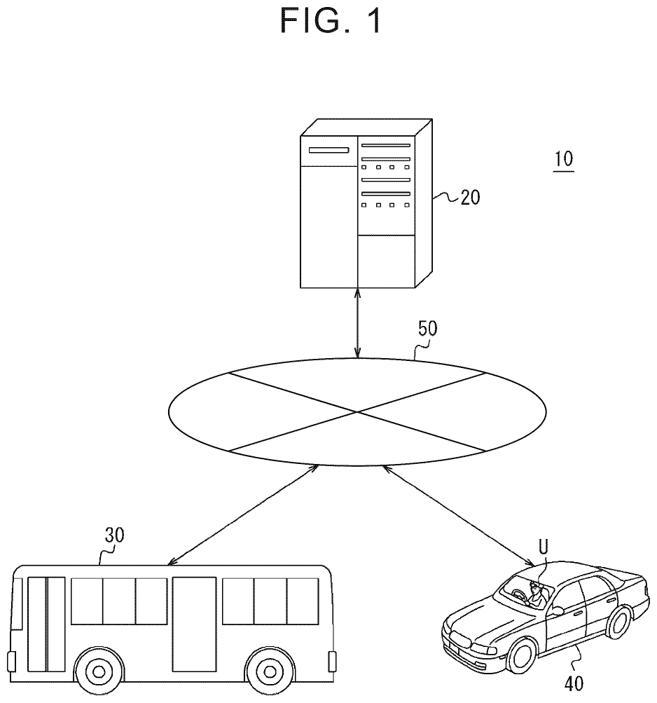

The configuration of a system 10 according to the present embodiment will be described with reference to FIG. 1.

The system 10 includes at least one power supply support device 20, at least one power supply vehicle 30, and at least one general vehicle 40. Note that there may be a plurality of power supply support devices 20, a plurality of power supply vehicles 30, and a plurality of general vehicles 40.

The power supply support device 20 is capable of communicating with the power supply vehicle 30 and the general vehicle 40 via the network 50. The power supply vehicle 30 may be capable of communicating with the general vehicle 40 via the network 50.

The power supply support device 20 is installed in a facility such as a data center. The power supply support device 20 is, for example, a server belonging to a cloud computing system or another computing system.

A battery or a generator is mounted on the power supply vehicle 30. The power supply vehicle 30 is a vehicle that moves to the power supply point P based on an instruction from the power supply support device 20 and provides a charging service to the general vehicle 40. In the following description, it is assumed that the power supply vehicle 30 is equipped with a battery.

The general vehicles 40 are any type of battery electric vehicle, such as, for example, HEV, PHEV, BEV, or FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The general vehicle 40 is a vehicle other than the power supply vehicle 30 and includes a vehicle owned by an individual and a commercial vehicle. The general vehicle 40 is a private vehicle in the present embodiment, but is not limited thereto, and may be any vehicle as long as it can be charged by electric power supplied from the power supply vehicle 30. In the present embodiment, the general vehicles 40 are driven by the driver as the user U, but may be an AV in which the driving is automated at any level. “AV” stands for autonomous vehicle. The level of autonomous driving is, for example, one of levels 1 to 5 in the SAE leveling, for example. “SAE” is an abbreviation for Society of Automotive Engineers.

The network 50 includes the Internet, at least one WAN, at least one MAN, or a combination thereof. “WAN” is an abbreviation for wide area network. “MAN” is an abbreviation for metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

In electric mobility such as a battery electric vehicle capable of storing electric power supplied from the outside of vehicles, it is known that the cruising range is shorter than that of a gasoline-powered vehicle. Generally, battery electric vehicle range is referred to as 200 to 600 km. Therefore, when traveling a long distance in battery electric vehicle, the timing of the charge needs to be planned at a higher frequency than that of the gasoline-powered vehicle. However, in the case of being caught in an unexpected traffic jam or the like, or in the case of stalling due to heavy snow or the like, it is not possible to reach the planned charging place, and there is a possibility that the charging state becomes a power-loss state. The “depleted state” refers to a state in which electric power for traveling is insufficient in battery electric vehicle. It is conceivable to dispatch a power supply vehicle into a train in the traffic jam in order to charge battery electric vehicle who stayed in the traffic jam, but it is difficult to pass through the train in the traffic jam. Furthermore, charging may take time, which may cause a new traffic jam. In addition, since the maintenance of the charging station requires an expensive installation cost, the number of installations and the installation location are currently limited.

In the system 10 according to the present embodiment, the power supply support device 20 acquires the traffic congestion prediction information D1 that predicts the traffic congestion of the vehicle generated for each road, and determines the distribution of the power supply vehicle 30 that supplies power to the general vehicle 40 having the external power supply function based on the acquired traffic congestion prediction information D1.

According to the present embodiment, when a traffic jam is predicted, the power supply vehicle 30 can be distributed in advance, and the general vehicle 40 can be easily charged before being caught in the traffic jam. Therefore, the general vehicle 40, even when caught in the traffic jam, it is less likely to be in a state of power loss. Further, since the installation location of the power supply vehicle 30 can be arbitrarily selected according to the situation of the traffic jam, the power supply vehicle 30 can be installed at an appropriate location as necessary without increasing the number of charging stations. Furthermore, the need to dispatch the power supply vehicle 30 during a traffic jam is reduced.

In the present embodiment, the power supply support device 20 distributes the power supply vehicle 30 in the vicinity of an area where a traffic jam is expected. Specifically, the power supply support device 20 predicts the position of the tail end E of the traffic congestion, and dispatches the power supply vehicle 30 before the predicted position. The power supply support device 20 may determine the dispatch of the power supply vehicle 30 when the size of the traffic jam is equal to or larger than a certain size. In addition, the power supply support device 20 may change the charging capacity (power supply capacity) of the battery mounted on the power supply vehicle 30 to be distributed in accordance with the size of the traffic jam. In addition, the power supply support device 20 may distribute the power supply vehicle 30 to a commercial facility and make use of the commercial facility convenient for the user U of the general vehicle 40 that has been charged from the power supply support device 20.

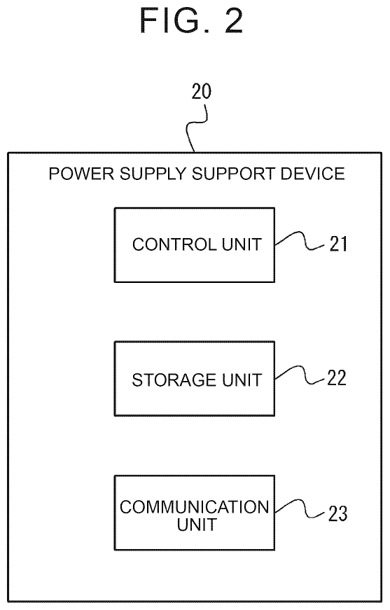

With reference to FIG. 2, a configuration of the power supply support device 20 according to the present embodiment will be described.

The power supply support device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processing related to the operation of the power supply support device 20 while controlling each unit of the power supply support device 20.

The storage unit 22 includes at least one semiconductor memory, at least one magnetic memory, at least one optical memory, or a combination of at least two of them. The semiconductor memory is, for example, a RAM or a ROM. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The storage unit 22 functions as, for example, a main storage device, an auxiliary storage device, or a cache memory. The storage unit 22 stores data used for the operation of the power supply support device 20 and data obtained by the operation of the power supply support device 20. The storage unit 22 may store traffic congestion prediction information D1 that predicts traffic congestion of vehicles occurring on a road-by-road basis.

The storage unit 22 may further store map information D2. The map information D2 is information indicating a map including a road on which a traffic jam is predicted and the surroundings of the road, in which a plurality of commercial facilities F capable of dispatching the power supply vehicles 30 are mapped.

The communication unit 23 includes at least one communication interface. The communication interface is, for example, a LAN interface. The communication unit 23 receives data used for the operation of the power supply support device 20 and transmits data obtained by the operation of the power supply support device 20. In the present embodiment, the communication unit 23 communicates with the power supply vehicle 30 and the general vehicle 40.

The function of the power supply support device 20 is realized by executing the program according to the present embodiment by a processor serving as the control unit 21. That is, the function of the power supply support device 20 is realized by software. The program causes the computer to function as the power supply support device 20 by causing the computer to execute the operation of the power supply support device 20. That is, the computer functions as the power supply support device 20 by executing the operation of the power supply support device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

Some or all of the functions of the power supply support device 20 may be realized by a programmable circuit or a dedicated circuit as the control unit 21. That is, some or all of the functions of the power supply support device 20 may be realized by hardware.

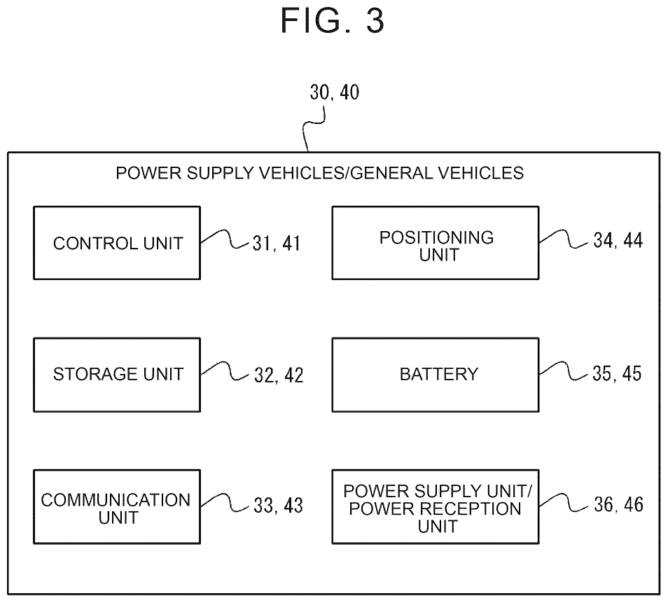

With reference to FIG. 3, a configuration of the power supply vehicle 30 and a configuration of the general vehicle 40 according to the present embodiment will be described. Since the power supply vehicle 30 and the general vehicle 40 have common components, the same drawings will be used to describe the same components. However, both are different in that the power supply vehicle 30 includes the power supply unit 36 and the general vehicle 40 includes the power reception unit 46.

The power supply vehicle 30 includes a control unit 31, a storage unit 32, a communication unit 33, a positioning unit 34, a battery 35, and a power supply unit 36. The general vehicle 40 includes a control unit 41, a storage unit 42, a communication unit 43, a positioning unit 44, a battery 45, and a power reception unit 46.

The control units 31 and 41 include at least one processor, at least one programmable circuit, at least one dedicated circuit, or any combination thereof. The processor is a general-purpose processor such as a CPU or a GPU, or a dedicated processor specialized for a specific process. The programmable circuit is, for example, an FPGA. The dedicated circuit is, for example, an ASIC. The control units 31 and 41 execute processes related to the operations of the power supply vehicle 30 and the general vehicle 40 while controlling the respective units of the power supply vehicle 30 and the general vehicle 40, respectively.

The storage units 32 and 42 include at least one semiconductor memory, at least one magnetic memory, at least one optical memory, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 32 functions as, for example, a main storage device, an auxiliary storage device, or a cache memory. The storage unit 32 stores data used for the operations of the power supply vehicle 30 and the general vehicle 40 and data obtained by the operations of the power supply vehicle 30 and the general vehicle 40.

The communication units 33 and 43 include at least one communication interface. The communication interface is, for example, a LAN interface. The communication units 33 and 43 receive data used for operations of the power supply vehicle 30 and the general vehicle 40, and transmit data obtained by operations of the power supply vehicle 30 and the general vehicle 40. In the present embodiment, the communication units 33 and 43 communicate with the power supply support device 20. The communication unit 33 of the power supply vehicle 30 may communicate with the general vehicle 40. The communication unit 43 of the general vehicle 40 may communicate with the power supply vehicle 30.

The positioning units 34, 44 include at least one GNSS receiver. “GNSS” is an abbreviation for global navigation satellite system. For example, the GNSS is GPS, QZSS, GLONASS or Galileo. “GPS” is an abbreviation for Global Positioning System. The “QZSS” is an abbreviation for quasi-zenith satellite system. A satellite for the QZSS is referred to as a quasi-zenith satellite. “GLONASS” is an abbreviation for Global Navigation Satellite System. The positioning units 34 and 44 measure the positions of the power supply vehicle 30 and the general vehicle 40, respectively. The position is represented by latitude, longitude, and the like.

The batteries 35 and 45 include, for example, a rechargeable secondary battery such as a lithium-ion secondary battery or a nickel-hydrogen secondary battery. Instead of the secondary battery, other power storage devices such as a multilayer capacitor may be employed as the batteries 35 and 45. The batteries 35 and 45 include control circuits for controlling current, voltage, temperature, and the like. The battery 35 may be a large battery mounted on a rear portion of the power supply vehicle 30 or the like. The battery 45 may be located anywhere within the general vehicle 40, such as under the rear seat of the general vehicle 40 or in a luggage compartment.

The power supply unit 36 is a portion that supplies the electric power of the battery 35 from the power supply vehicle 30 to the general vehicle 40. The power supply unit 36 can be configured to include, for example, a power supply cable and a connector or the like provided at a distal end of the power supply cable.

The power reception unit 46 receives a supply of electric power from the outside in order to charge the battery 45. The power reception unit 46 includes a charging port. The charging port includes a charging inlet for connecting a connector of a charging cable from the power supply vehicle 30. The charging port may be disposed at any position, such as an upper portion of a front grille of the general vehicle 40, a front fender, a rear fender, and a rear bumper.

Although the power supply from the power supply vehicle 30 to the general vehicle 40 has been described as being performed by contact charging using a power supply cable or the like, the present disclosure is not limited thereto, and may be performed by non-contact charging that wirelessly transmits power using a power transmission coil, a power reception coil, or the like, for example.

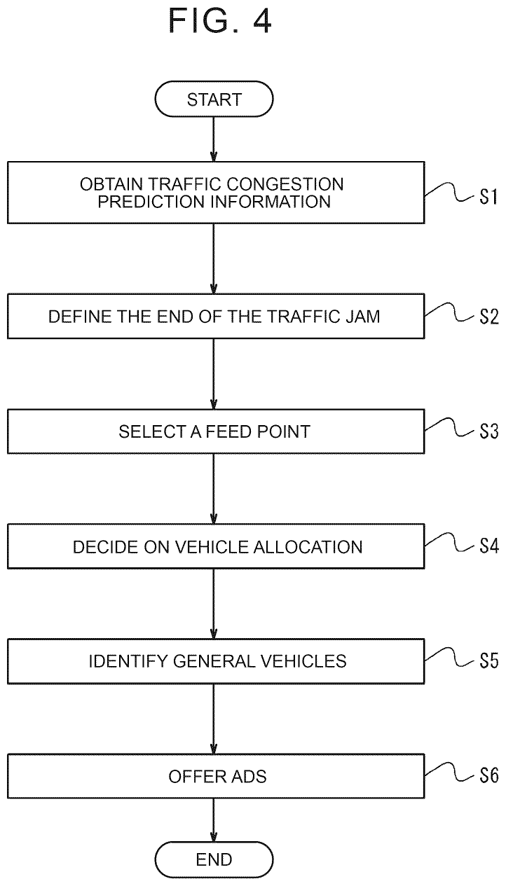

The configuration of the system 10 according to the present embodiment will be described with reference to FIG. 4. The operation corresponds to the control method according to the present embodiment.

In S1 (hereinafter, the steps of the flow chart are specified by S and numbers), the control unit 21 of the power supply support device 20 acquires the traffic congestion prediction information D1 that predicts the traffic congestion of the vehicles generated on a road-by-road basis. The traffic congestion prediction information D1 may be obtained in any manner. For example, the control unit 21 communicates with an external server installed in a traffic information center or the like via the communication unit 23, and acquires the traffic congestion prediction information D1 by receiving the traffic congestion prediction information D1 transmitted from the external server. Alternatively, when there is a plurality of general vehicles 40 including the general vehicle 40′, the control unit 21 may communicate with the plurality of general vehicles 40 to predict the congestion based on the travel history of the general vehicles 40 and the like, and obtain the predicted outcome as the traffic congestion prediction information D1. The traffic congestion prediction information D1 includes, for example, identification information of a road R on which a traffic jam is predicted to occur, an expected occurrence time, position information of a start point PS of the traffic jam, position information of an end point PT, and the like. The control unit 21 may store the acquired traffic congestion prediction information D1 in the storage unit 22.

In S2, the control unit 21 of the power supply support device 20 defines a tail end E of a traffic congestion predicted on a certain road on the basis of the traffic congestion prediction information D1 obtained by S1. As an example, suppose that the traffic congestion prediction information D1 indicates that a traffic jam is predicted to occur from the start point PS1 to the end point PT1 in a certain road R1. The control unit 21 refers to the traffic congestion prediction information D1 and defines, as the tail end E of the traffic congestion expected in the road R1, a position indicated by the position information of the end point PT1 indicated by the traffic congestion prediction information D1 with respect to the road R1.

In S3, the control unit 21 of the power supply support device 20 selects the power supply point P for distributing the power supply vehicles 30. The control unit 21 selects, as the power supply point P, a location located behind the tail end E of the traffic congestion defined by S2. Here, “rear” means a direction opposite to the traveling direction of the traffic jam.

The power supply point P at which the power supply vehicle 30 is distributed may be arbitrarily selected as long as the power supply point P is located behind the tail end E of the traffic congestion. In the present embodiment, the control unit 21 of the power supply support device 20 selects the power supply point P in the following procedure.

In the first step, the control unit 21 of the power supply support device 20 acquires the map information D2. In the present embodiment, the map information D2 is a map including a road R1 in which traffic congestion is predicted and the vicinity of the road R1. In the present embodiment, a plurality of commercial facilities F registered as locations where the power supply vehicles 30 can be distributed are mapped to the map indicated by the map information D2. Examples of “commercial facilities” include, for example, shops such as shopping centers, supermarkets, convenience stores, discount stores, department stores, mass retailers, toy stores, bookstores, car goods stores, clothing stores, sporting goods stores, or fast food stores, or stores such as banks, or locations that sell some goods or provide some service. The map information D2 may be obtained in any manner. In the present embodiment, the map information D2 is stored in advance in the storage unit 22, and the control unit 21 acquires the map information D2 by reading the map information D2 from the storage unit 22.

In the second procedure, the control unit 21 of the power supply support device 20 selects, as the power supply point P, a commercial facility F′ that is located behind the tail end E defined by S2 and is closest to the tail end E among the plurality of commercial facilities F′ indicated by the map information D2 acquired in the first procedure.

In S4, the control unit 21 of the power supply support device 20 determines the dispatch of the power supply vehicles 30. Specifically, the control unit 21 determines the dispatch of the power supply vehicles 30 to the power supply point P selected by S4. The dispatch of the power supply vehicle 30 may be determined by an arbitrary procedure, but is determined by, for example, the following procedure. The control unit 21 of the power supply support device 20 generates a dispatch instruction X instructing the power supply vehicle 30 to move to the power supply point P. The dispatch instruction X includes positional information of the power supply point P. The control unit 21 transmits the generated dispatch instruction X to the power supply vehicle 30 via the communication unit 23. The power supply vehicle 30 receives the dispatch instruction X via the communication unit 33, and moves to a position indicated by the position information of the power supply point P included in the received dispatch instruction X. In this way, the power supply vehicle 30 is distributed to the power supply point P.

As described above, the power supply support device 20 acquires the traffic congestion prediction information D1 that predicts the traffic jam of the vehicle generated for each road, and determines the distribution of the power supply vehicle 30 that supplies power to the general vehicle 40 having the external power supply function based on the acquired traffic congestion prediction information D1.

According to this configuration, when a traffic jam is predicted, the power supply vehicle 30 can be distributed in advance. Further, since the power supply vehicle 30 is distributed before the tail end of the traffic jam predicted on a certain road, the general vehicle 40, which is a battery electric vehicle, can stop at the power supply point P and charge from the power supply vehicle 30 prior to being caught in the traffic jam. As a result, even if the general vehicle 40 is caught in a traffic jam, it is less likely that the general vehicle will be in an electric power shortage state.

As a modification of the present embodiment, the control unit 21 of the power supply support device 20 may determine the dispatch of the power supply vehicle 30 when the size of the traffic jam is equal to or larger than a certain value. The magnitude of the congestion can be expressed, for example, by the distance d. For example, the control unit 21 may determine whether the distance d from the start point PS1 to the end point PT1 is equal to or greater than the threshold Th1 based on the traffic congestion prediction information D1 acquired by S1, and determine the dispatch of the dispatch of the power supply vehicle 30 when the distance d is equal to or greater than the threshold Th1. The thresholds Th1 may be any value, but may be arbitrarily set, for example, a value calculated by multiplying the mean range (e.g., 200 to 600 km) of battery electric vehicle by a predetermined factor.

Since the number of the power supply vehicles 30 is limited, if the power supply vehicles 30 are distributed every time a traffic jam is predicted, the power supply vehicles 30 may be insufficient. According to the present modification, the power supply vehicle 30 is selectively disposed. Therefore, even when the number of the power supply vehicles 30 is limited, the power supply vehicles 30 can be efficiently distributed.

As a modification of the present embodiment, when determining the distribution of the power supply vehicle 30 in S4, the control unit 21 of the power supply support device 20 may determine the size of the congestion in which the tail end E is defined based on the traffic congestion prediction information D1, and determine the power supply capacity of the power supply vehicle 30 according to the determined size of the congestion. Specifically, the control unit 21 may increase the charging capacity (power supply capacity) of the battery 35 in the power supply vehicle 30 as the size of the traffic jam increases. For example, the power supply capacity per unit distance may be determined in advance, and the control unit 21 may determine a value calculated by multiplying the distance expressed as the size of the traffic jam by the power supply capacity per unit distance as the power supply capacity in the power supply vehicle 30.

According to the present modification, since the power-supplying capacity of the power supply vehicle 30 is determined according to the magnitude of the traffic jam, it is easy to avoid a situation in which the power-supplying capacity of the power supply vehicle 30 is insufficient.

As a modification of the present embodiment, it is assumed that the commercial facility F′ is selected as the power supply point P in S3, and power is supplied to the general vehicles 40′. The control unit 21 of the power supply support device 20 may specify the general vehicle 40′ to which power is supplied from the power supply vehicle 30 distributed to the commercial facility F′, and perform control to present an advertising AD1 for promoting the commercial facility F′ toward the user U′ of the specified general vehicle 40′. The user U′ is, for example, a driver of the general vehicle 40′. Specifically, the control unit 21 may further perform the following S5 and S6 processes.

In S5, the control unit 21 of the power supply support device 20 specifies the general vehicle 40′ that is supplied with power from the power supply vehicle 30 distributed to the commercial facility F′ selected as the power supply point P. The general vehicle 40′ may be specified by any procedure, but is specified by, for example, the following procedure.

For example, the control unit 21 of the power supply support device 20 acquires the vehicle identification information D3 including the vehicle identifier ID′ for identifying the general vehicle 40′ to which power is supplied from the power supply vehicle 30, and identifies the general vehicle 40′ based on the vehicle identifier ID′ indicated by the acquired vehicle identification information D3. The vehicle identification information D3 may be acquired by the power supply support device 20 in any procedure, but in the present embodiment, it is acquired by the following procedure.

When the control unit 41 of the general vehicle 40 detects that the connector as the power supply unit 36 of the power supply vehicle 30 is connected to the charging port as the power reception unit 46′ of the general vehicle 40′, it generates information including the vehicle identifier ID′ of the general vehicle 40′ as the vehicle identification information D3. The control unit 41 transmits the generated vehicle identification information D3 to the power supply support device 20 via the communication unit 43. The control unit 21 of the power supply support device 20 receives the vehicle identification information D3 transmitted from the general vehicle 40′ via the communication unit 23. In this way, the control unit 21 acquires the vehicle identification information D3.

Alternatively, the vehicle identification information D3 may be transmitted from the power supply vehicle 30 to the power supply support device 20. Specifically, when the control unit 31 of the power supply vehicle 30 detects that the connector serving as the power supply unit 36 is connected to the charging port serving as the power reception unit 46′ of the general vehicle 40′, it may communicate with the general vehicle 40′ via the communication unit 33 and receive the vehicle identification information D3 transmitted from the general vehicle 40′. The control unit 31 may transmit the received vehicle identification information D3 to the power supply support device 20 via the communication unit 33.

In S6, the control unit 21 of the power supply support device 20 performs control to present an advertising AD1 for promoting F′ of the commercial establishment toward the user U of the general vehicle 40′ specified by S5. For example, it is assumed that the user U′ of the general vehicle 40′ is associated with the vehicle identifier ID′ of the general vehicle 40′ in advance. The control unit 21 specifies the user U′ associated with the vehicle identification ID′ of the general vehicle 40′ as the user U′ of the general vehicle 40′. The control unit 21 performs control for displaying a notification N1 as an advertising AD1 for promoting the commercial establishment F′ on the terminal device TL′ held by the specified user U′. Specifically, the control unit 21, as a notification N1, “Thank you for charging. We are currently issuing a Thank You Coupon that can be used at commercial facility F′!” A message M1 is generated and transmitted to the terminal device TL′. The message M1 may include coupon information such as a discount ticket. The terminal device TL′ displays the message M1 transmitted from the power supply support device 20 on the terminal device TL′. Alternatively, the control unit 21 of the power supply support device 20 may communicate with the general vehicle 40′ to perform control for displaying the notification N1 on the in-vehicle indicator of the general vehicle 40′. Specifically, the control unit 21 may transmit the message M1 as the notification N1 to the general vehicles 40′. The general vehicle 40′ may present the message M1 transmitted from the power supply support device 20 to the user U′ by displaying the message M1 on the display of the in-vehicle display mounted on the general vehicle 40′. Alternatively, the control unit 21 may perform control such that a message M1 as a notification N1 is printed on a receipt issued when charging of the general vehicle 40′ is completed. As another example, the general vehicle 40 may be configured to be able to transmit position information indicating the position of the general vehicle 40 to the power supply support device 20 during power supply from the power supply vehicle 30. Instead of specifying the user U′ associated with the vehicle identifier ID′ of the general vehicle 40′, the control unit 21 of the power supply support device 20 may perform control to acquire the position information transmitted from the general vehicle 40′ being charged, determine the terminal device at the same position as the position indicated by the acquired position information as the terminal device TL′, and display the message M1 on the determined terminal device TL′.

According to the present modification, the user U′ that has charged the general vehicle 40 from the power supply vehicle 30 is prompted to use the commercial facility F′. If the user U′ stops at the commercial facility F′, the general vehicles 40 are not caught up in the traffic jam. In addition, F′ of commercial facilities also has the advantage that it is expected to benefit from an increase in the number of customers. Further, if the number of users U who stop at the commercial establishment F′ increases, the number of vehicles traveling on the road R1 in the traffic jam decreases, and consequently, the traffic jam may be alleviated. Therefore, the general vehicle 40 is less likely to be caught in a traffic jam. As a result, the general vehicle 40 is less likely to be in a power-depletion state.

In the present embodiment, one or more users U may be registered in advance in the power supply support device 20. Registration of the user U may be performed by an arbitrary procedure, but is performed by, for example, the following procedure. The user U who intends to use the system 10 uses the terminal device TL held by the user U to register the use. Specifically, the user U inputs a sign-in information D4 required for registering to each terminal device TL. The sign-in information D4 includes, for example, vehicle identification ID for identifying the general vehicle 40 that the user U is driving. The terminal device TL receives the sign-in information D4 from the user U. The terminal device TL transmits the sign-in information D4 inputted by the respective users U to the power supply support device 20.

The power supply support device 20 acquires the sign-in information D4 transmitted from the terminal device TL. Specifically, the control unit 21 of the power supply support device 20 communicates with the terminal device TL via the communication unit 23, and receives the sign-in information D4 transmitted from the terminal device TL. The control unit 21 stores the received sign-in information D4 in the storage unit 22. In this way, one or more users U using the system 10 are registered in the power supply support device 20.

The control unit 21 of the power supply support device 20 may notify the registered one or more users U of the power supply promotion information D5 for prompting the power supply. Specifically, when the traffic congestion prediction information D1 is acquired in S1, the control unit 21 may notify the registered one or more users U of the acquired traffic congestion prediction information D1 as the power supply promotion information D5. For example, the control unit 21 may transmit the traffic congestion prediction information D1 to each terminal device TL of the user U via the communication unit 23. Alternatively, when the control unit 21 determines the distribution of the power supply vehicle 30 in S4, it may notify the respective users U that the power supply vehicle 30 is distributed to the power supply point P as the power supply promotion information D5. Specifically, the control unit 21 may transmit the position information indicating the position of the power supply point P as the power supply promotion information D5 to the terminal device TL via the communication unit 23. Further, the control unit 21 may perform control to present advertising AD2′ for promoting F′ of commercial facilities selected as the power supply point P to the respective users U. Specifically, the control unit 21 performs control for displaying a notification N2 as an advertising AD2′ for promoting the commercial establishment F′ on the terminal device TL held by each of the registered users U. For example, as the notification N2, the control unit 21 “a person who has charged at the commercial facility F′ is issuing a thank-you coupon that can be used at the commercial facility F′!” A message M2 is generated and transmitted to the terminal device TL. The message M2 may include coupon announcement, such as a discount coupon, that can be used in the commercial F′ after being charged. The terminal device TL displays the message M2 transmitted from the power supply support device 20 on the screen of the terminal device TL. Alternatively, the control unit 21 of the power supply support device 20 may perform control to communicate with one or more general vehicles 40 and display the notification N2 on the respective in-vehicle displays of the general vehicles 40. Specifically, the control unit 21 may transmit the message M2 as the notification N2 to the general vehicles 40. The general vehicle 40 may present the message M2 transmitted from the power supply support device 20 to the user U by displaying the message M2 on the display of the on-vehicle display device mounted on the general vehicle 40.

According to this configuration, it is widely notified that the traffic jam is predicted and that the power supply vehicle 30 is distributed to the power supply point P to one or more users U who have registered the use of the system 10. Therefore, the user U is prompted to perform charging at the power supply point P in advance before being involved in the traffic jam. Further, as compared with the case where the notification N1 is performed by specifying the general vehicle 40′ of the user U′ after the charge, since more users U are prompted to stop at the commercial facility F′ as the power supply point P, the number of the general vehicles 40 involved in the traffic jam can be further reduced by the number of users U. Further, the commercial establishment F′ also has an advantage that an increase in the number of visiting users U is expected to result in a higher profit. Further, if the number of users U who stop at the commercial establishment F′ increases, the number of general vehicles 40 traveling on the road R1 in the traffic jam decreases, and consequently, the traffic jam may be alleviated. Therefore, each general vehicle 40 is less likely to be caught in a traffic jam. As a result, the general vehicle 40 is less likely to be in a power-depletion state.

The present disclosure is not limited to the embodiment described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

What is claimed is:

1. A power supply support device comprising a control unit that acquires traffic congestion prediction information on predicted traffic congestion with vehicles generated for each road, and that determines distribution of a power supply vehicle that supplies power to a general vehicle having an external power supply function based on the acquired traffic congestion prediction information.

2. The power supply support device according to claim 1, wherein the control unit defines a tail end of traffic congestion predicted on a certain road based on the traffic congestion prediction information, selects a location behind the defined tail end as a power supply point, and determines distribution of the power supply vehicle to the selected power supply point.

3. The power supply support device according to claim 2, wherein the control unit determines a scale of the traffic congestion, the tail end of which has been defined, based on the traffic congestion prediction information, and determines a power supply capacity of the power supply vehicle according to the determined scale.

4. The power supply support device according to claim 2, wherein:
the control unit acquires map information that indicates a map in which a plurality of commercial facilities registered as a location that enables distribution of the power supply vehicle is mapped, the map including a road on which the traffic congestion is predicted and a periphery of the road; and
the control unit selects, as the power supply point, a commercial facility that is located behind the tail end and at a shortest distance from the tail end, among the commercial facilities indicated in the map information.

5. The power supply support device according to claim 4, wherein the control unit specifies a general vehicle supplied with power from the power supply vehicle distributed to the commercial facility selected as the power supply point, and presents an advertisement for promoting the commercial facility to a user of the specified general vehicle.
